(19) United States
(12) Patent Application Publication
(10) Pub. No.: US 2024/0390220 A1
(43) Pub. Date: Nov. 28, 2024

(54) FASCIAL GUN

(71) Applicant: SHENZHEN KAIYAN MEDICAL EQUIPMENT CO., LTD, Shenzhen (CN)

(72) Inventors: Alain Dijkstra, Amstelveen (NL); Chen Shoufeng, Shenzhen (CN)

(73) Assignee: SHENZHEN KAIYAN MEDICAL EQUIPMENT CO., LTD, Shenzhen (CN)

(21) Appl. No.: 18/490,803

(22) Filed: Oct. 20, 2023

(30) Foreign Application Priority Data
May 22, 2023 (CN) 202321236212.0

(51) Int. Cl. A61H 23/00; A61H 23/02

(52) U.S. Cl. CPC A61H 23/006; A61H 23/02; A61H 2201/0107; A61H 2201/0165

(57) ABSTRACT

Embodiments of the present invention provides a fascial gun including a fascial gun body. Further, the fascial gun includes a gun head protruding from the fascial gun body and configured to be imparted reciprocating motion by an actuator comprised within the fascial gun body. The fascial gun further includes a massage head. Also, the fascial gun includes a vibration adjusting device connecting the massage head with the gun head, the vibration adjusting device configured to at least partially transmit the reciprocating motion of the gun head to the massage head. The vibration adjusting device comprises a gas chamber provided with an exhaust regulator valve configured to adjust maximum allowable gas pressure in the gas chamber thereby adjusting an amplitude of the reciprocating motion transmitted to the massage head.

### TECHNICAL FIELD

The present invention generally relates to therapeutic and recreational devices. More specifically the present invention relates to fascial guns used for massaging purposes.

### BACKGROUND ART

A fascial gun is a great tool to help with recovery after a workout. Professional athletes, and amateur bodybuilders, both can use the fascial guns for massaging several parts of their body. Vibrating massage provided by fascial guns mainly provides relief to large muscle groups by relaxing the muscle groups and reducing soreness thereby allowing more effective training. However, there is often soreness in other areas of the body that cannot be ignored, whether it is a professional athlete or a general leisure enthusiast all have experienced muscle soreness. The fascial guns use several vibration frequencies to relieve muscle spasms and increase blood flow, thereby dramatically shortening muscle recovery time. Traditional fascial guns are handheld, as shown in FIG. 1, including a facial gun 110 used by a user 120.

CN210872918U discloses a handheld fascial gun with a brush motor with a driving part provided within a fascial gun body of the handheld fascial gun. The driving part includes a reciprocating mechanism mechanically coupled with a massage head. Therefore, the massage head reciprocates due to the reciprocating motion of the reciprocating mechanism, thereby providing a vibrating massage effect on the body of a user.

However, exposed ends of the existing fascial guns make a straight reciprocating motion with fixed amplitudes. The only parameter that generally can be adjusted when using the existing fascial guns is the frequency of vibration. However, the lack of provisions for adjusting the depth and strength of the massage provided by the fascial guns prevents them from being adopted by larger user groups.

### OBJECTS OF THE INVENTION

Some of the objects of the invention are as follows:

An object of the invention is to provide a fascial gun that can reduce muscle soreness, provide pain relief, and increase blood circulation;

Another object of the invention is to provide a fascial gun that can be adopted by a larger variety of user groups in addition to professional bodybuilders and amateur athletes;

Another object of the invention is to provide a fascial gun where the amplitude of the reciprocating motion of the massage head is adjustable; and

It is also an object of the invention that the fascial gun with adjustable amplitude is simple in construction.

### SUMMARY OF THE INVENTION

According to a first aspect of the present invention, there is provided a fascial gun. The fascial gun includes a fascial gun body. Further, the fascial gun includes a gun head protruding from the fascial gun body and configured to be imparted reciprocating motion by an actuator comprised within the fascial gun body. The fascial gun further includes a massage head. Also, the fascial gun includes a vibration adjusting device connecting the massage head with the gun head, the vibration adjusting device configured to at least partially transmit the reciprocating motion of the gun head to the massage head. The vibration adjusting device comprises a gas chamber provided with an exhaust regulator valve configured to adjust maximum allowable gas pressure in the gas chamber thereby adjusting an amplitude of the reciprocating motion transmitted to the massage head.

In one embodiment of the invention, the actuator is selected from a group consisting of an electrical motor, a linear electromagnetic motor, a piezoelectric actuator, a pneumatic actuator, and a hydraulic actuator.

In one embodiment of the invention, the vibration adjusting device is detachably fastened with the massage head through one or more of: mating of external threads of the vibration adjusting device with internal threads of a hole in the massage head, a snap-fit arrangement, and a press-fit arrangement.

In one embodiment of the invention, the vibration adjusting device includes a vibration body comprising a first portion and a second portion, the first portion configured to be fastened to the massage head, and the second portion formed at least in part in form of a cylinder comprising a second hollow space therewithin, the second hollow space provided with the exhaust regulator valve. The vibration adjusting device further includes a separating wall disposed between the first portion and the second portion. Also, the vibration adjusting device includes a piston including a first piston end and a second piston end, the piston configured to be at least partially disposed within the second hollow space with the first piston end configured to be socketed by the second portion. A portion of the second hollow space between the first piston end and the separating wall defines the gas chamber. The second piston end includes a piston mounting head, the piston mounting head configured to be detachably fastened to the gun head. The reciprocating motion of the gun head is configured to impart reciprocating motion to the piston. The reciprocating motion of the piston is configured to impart reciprocating motion to the vibration body. Also, the reciprocating motion of the vibration body is configured to impart reciprocating motion to the massage head.

In one embodiment of the invention, the fascial gun further includes a deformable element disposed between the first piston end and the separating wall.

In one embodiment of the invention, the deformable element is selected from a group consisting of a compression spring, a diaphragm, and a fluid chamber filled with a compressible fluid.

In one embodiment of the invention, the piston mounting head is configured to be detachably fastened to the gun head through one or more of: mating of external threads of the piston mounting head with internal threads of a hole in the gun head, mating of external threads of the gun head with internal threads of a hole in the piston mounting head, a snap-fit arrangement, and a press-fit arrangement.

In one embodiment of the invention, the piston mounting head is configured to be detachably fastened to the gun head through one or more the snap-fit arrangement and the press-fit arrangement, the piston mounted head configured to be socketed by the gun head, and outer surface of the piston mounting head provided with one or more third slip rings to prevent relative rotation between the piston mounting head and the gun head.

In one embodiment of the invention, the first end of the piston comprises a radial protrusion, wherein the radial protrusion is configured to be in contact with the deformable element.

In one embodiment of the invention, the first portion is cylindrical in shape and is configured to be socketed by a hole in the massage head, the first portion comprising one or more second slip rings on an outer surface of the first portion to prevent relative rotation between the first portion and the massage head.

According to a second aspect of the present invention, there is provided a vibration adjusting device for a fascial gun. The fascial gun includes a massage head and a gun head. The vibration adjusting device is configured to connect the gun head with the massage head. The vibration adjusting device includes a vibration body comprising a first portion and a second portion, the first portion configured to be fastened to the massage head, and the second portion formed at least in part in form of a cylinder comprising a hollow space therewithin, the hollow space provided with an exhaust regulator valve. Further, the vibration adjusting device includes a separating wall disposed between the first portion and the second portion. Also, the vibration adjusting device includes a piston including a first piston end and a second piston end. The piston is configured to be at least partially disposed within the hollow space with the first piston end configured to be socketed by the second portion. A portion of the hollow space between the first piston end and the separating wall define a gas chamber. The second piston end includes a piston mounting head, the piston mounting head configured to be detachably fastened to the gun head. The reciprocating motion of the gun head is configured to impart reciprocating motion to the piston. The reciprocating motion of the piston is configured to impart reciprocating motion to the vibration body. The reciprocating motion of the vibration body is configured to impart reciprocating motion to the massage head. Also, the exhaust regulator valve is configured to adjust maximum allowable gas pressure in the gas chamber thereby adjusting an amplitude of the reciprocating motion transmitted to the massage head.

In one embodiment of the invention, the vibration adjusting device further includes a deformable element disposed between the first piston end and the separating wall.

In one embodiment of the invention, the deformable element is selected from a group consisting of a compression spring, a diaphragm, and a fluid chamber filled with a compressible fluid.

In one embodiment of the invention, the piston mounting head is configured to be detachably fastened to the gun head through one or more of: mating of external threads of the piston mounting head with internal threads of a hole in the gun head, mating of external threads of the gun head with internal threads of a hole in the piston mounting head, a snap-fit arrangement, and a press-fit arrangement.

In one embodiment of the invention, the piston mounting head is configured to be detachably fastened to the gun head through one or more the snap-fit arrangement and the press-fit arrangement, the piston mounted head configured to be socketed by the gun head, and outer surface of the piston mounting head provided with one or more third slip rings to prevent relative rotation between the piston mounting head and the gun head.

In one embodiment of the invention, the first end of the piston includes a radial protrusion, wherein the radial protrusion is configured to be in contact with the deformable element.

In one embodiment of the invention, the vibration adjusting device further includes a front cushion and a rear cushion at a front end and a rear end, respectively, of stroke length of the piston.

In one embodiment of the invention, the vibration adjusting device further includes a piston sealing ring provided on an outer surface of the radial protrusion, the piston sealing ring configured to seal the gas chamber to prevent leakage of air or a gaseous substance from a gap in between the outer surface of piston and an inner surface of the second part.

In one embodiment of the invention, the first portion is cylindrical in shape and is configured to be socketed by a hole in the massage head, the first portion comprising one or more second slip rings on an outer surface of the first portion to prevent relative rotation between the first portion and the massage head.

In one embodiment of the invention, the exhaust regulator valve is selected from a group consisting of globe valves, gate valves, needle valves, plug valves, and butterfly valves.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates a use case scenario depicting a user using a fascial gun, in accordance with the prior art;

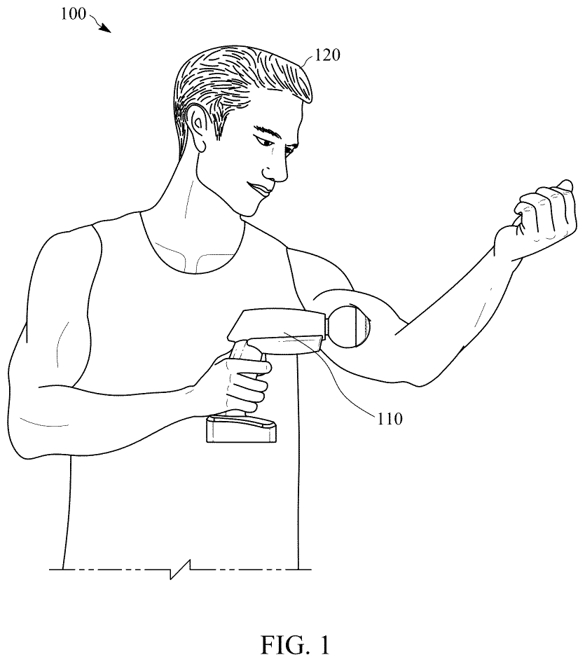

FIG. 2 illustrates a fascial gun, in accordance with an embodiment of the present invention;

FIG. 3 illustrates a side view of an assembly of a massage head and a vibration adjusting device, in accordance with an embodiment of the present invention;

FIG. 4 illustrates an exploded view of the assembly of FIG. 3; and

FIG. 5 illustrates a partial side-sectional view of the vibration adjusting device, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

It is envisaged that a fascial gun be provided with a vibration adjusting device that is capable of adjusting an amplitude of vibration of a massage head of the fascial gun. In that regard, the fascial gun may include a gun head configured to be reciprocated using an actuator. The reciprocating motion of the gun head may be transferred to the massage head through a vibration adjusting device. The vibration adjusting device may include a gas chamber capable of trapping air or any other gas therewithin. The gas chamber may further be provided with an exhaust regulator valve that may be configured for maximum allowable gas pressure in the gas chamber before the exhaust regulator valve opens and allows the trapped air or gas to escape. The gas chamber may be defined within a hollow vibration body and between a separating wall and a piston coupled to the gun head.

As the piston would compress the trapped air or gaseous substance within the gas chamber, a forward linear motion would be imparted to the vibration body. The forward linear motion of the vibration body would be transmitted to the massage head due to a direct coupling of the massage head with the vibration body. Once the maximum allowable gas pressure is attained inside the gas chamber, the exhaust regulator valve will open and release the pressure within the gas chamber and any further motion of the piston will have minimal effect on the vibration body. A deformable element provided between the piston and the separating valve will cause the vibration body to return to an original position of the vibration body as the piston retracts during a backward stroke of the reciprocating motion of the gun head. Therefore, the adjustment of the exhaust regulator wall would be able to affect the amplitude of vibration of the massage head.

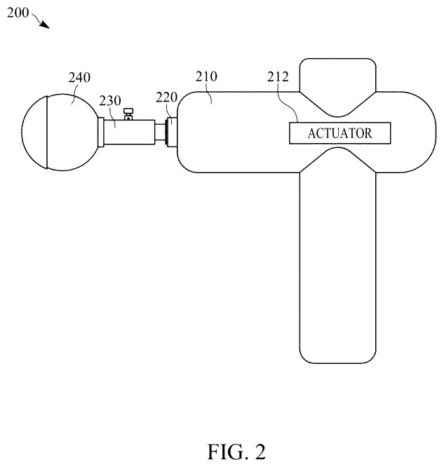

Several embodiments of the present invention will now be explained in detail taking FIGS. 2-5 as references.

FIG. 2 illustrates a fascial gun 200, in accordance with an embodiment of the present invention. The fascial gun 200 includes a fascial gun body 210. The facial gun body 210 is envisaged to be a housing for containing or encapsulating several components of the fascial gun 200. In this regard, the fascial gun body 210 may be made from Polyethylene Terephthalate (PET), High-density Polyethylene (HDPE), Polyvinyl Chloride (PVC), Low-density Polyethylene (LDPE), Polypropylene (PP), Polycarbonate (PC), etc. The fascial gun 200 further includes a gun head 220 protruding from the fascial gun body 210. The gun head 220 is configured to be imparted reciprocating motion by an actuator 212 comprised within the fascial gun body 210. In that regard, the actuator 212 may be selected from a group consisting of an electrical motor, a linear electromagnetic motor, a piezoelectric actuator, a pneumatic actuator, and a hydraulic actuator. Further, the electrical motor may be an Alternating Current (AC) motor or a Direct Current (DC) motor.

The fascial gun 200 further includes a massage head 240 for providing reciprocating or vibrating massage to a body of a user. In that regard, the reciprocating motion of the gun head 220 may at least partially be configured to be transmitted to the massage head 240 through a vibration adjusting device 230 provided between the gun head 220 and the massage head 240. The vibration adjusting device 230 may be detachably fastened to the massage head 240 through one or more of: mating of external threads of the vibration adjusting device 230 with internal threads of a hole in the massage head 240, a snap-fit arrangement, a press-fit arrangement, and combinations thereof, without departing from the scope of the invention.

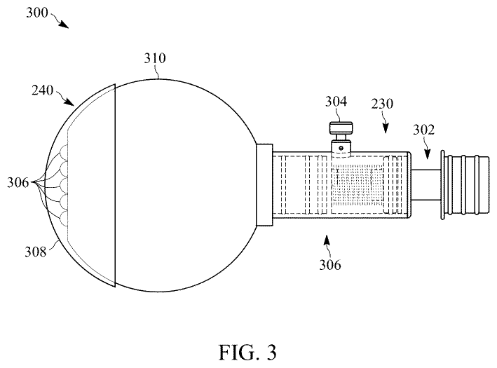

FIG. 3 illustrates a side view of an assembly 300 of the massage head 240 and the vibration adjusting device 230, in accordance with an embodiment of the present invention. The massage head 240 includes an oblate spheroidal body 310. A front portion of the oblate spheroidal body 310, configured to be facing the user has been provided with a plurality of stimulation elements 306. The plurality of stimulation elements 306 may include but are not limited to, one or more of: Light Emitting Diodes (LEDs), heating elements, cooling elements, vibration elements, electrodes, and combinations thereof. The LEDs may be configured to emit radiation in visible light and infrared frequencies of the electromagnetic spectrum. In other words, the wavelengths of the light emitted by the LEDs may lie in the ranges of 380 nm to 700 nm for the visible light and 845 nm to 855 nm for the infrared light. Further, the LEDs may be configured to operate in a pulsed or a continuous mode of operation. The heating elements may be selected from a group consisting of metal heating elements, ceramic heating elements, semiconductor heating elements, thick film heating elements, polymer-based heating elements, composite heating elements, and combination heating elements. The cooling elements may be thermoelectric coolers, also known as Peltier heat pumps. The vibration elements may include eccentric rotating motors or linear resonant actuators.

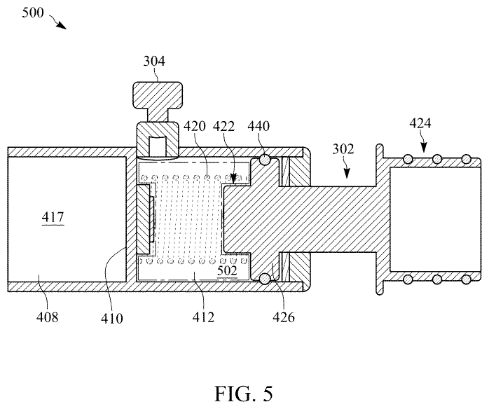

Further, the front portion of the oblate spheroidal body 310 may be provided with a protective cap 308 for protection of the plurality of stimulation elements 306 from ingress of dust, water, etc. In several embodiments of the invention, where the plurality of stimulation elements 306 include LEDs, the protective cap 308 may be made up of diaphanous material. The vibration adjusting device 230 includes a vibration body 306 and a piston 302. Furthermore, an exhaust regulator valve 304 (See FIG. 5) has been coupled to an orifice in the vibration body 306. The exhaust regulator valve 304 may be selected from a group consisting of globe valves, gate valves, needle valves, plug valves, and butterfly valves.

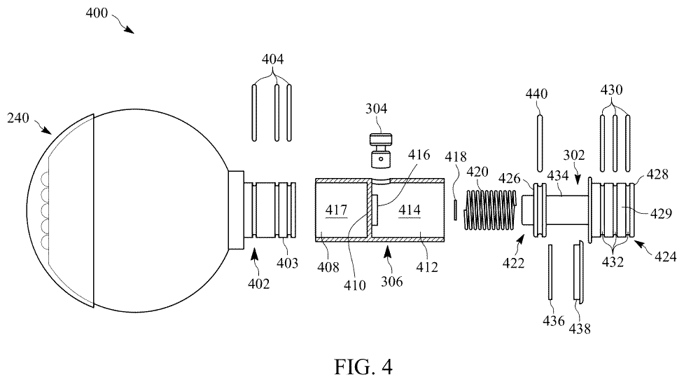

FIG. 4 illustrates an exploded view 400 of the assembly 300 of FIG. 3. The vibration body 306 includes a first portion 408 and a second portion 412. Further, a separating wall 410 has been disposed between the first portion 408 and the second portion 412. The first portion 408 is configured to be fastened to the massage head 240. In that regard, the first portion 408 includes a first hollow space 417. In several embodiments of the invention, the first hollow space 417 has a circular cross-section. However, in several alternate embodiments, the first hollow space 417 may acquire a polygonal cross-section, without departing from the scope of the invention.

The massage head 240 includes a rearward protrusion 402 extending towards the vibration body 306. The rearward protrusion 402 includes a first external surface 403. Further, the rearward protrusion 402 has a cross-section that is in conformance with the cross-section of the first hollow space 417. The massage head 240, therefore, may be fastened to the vibration body 306 by inserting the rearward protrusion 402 into the first hollow space 417. Relative sliding or rotating motion between the rearward protrusion 402 and the first portion 408 may be prevented by providing a first set of slip rings 404 at the first external surface 403. In several alternate embodiments of the invention, the first portion 408 may be cylindrical and may be configured to be socketed by a hole in the massage head 240. In that regard, the first portion 408 may further include one or more second slip rings (not shown) on an outer surface of the first portion 408 to prevent relative rotation between the first portion 408 and the massage head 240.

The second portion 412 of the vibration body 306 is formed at least in part in the form of a cylinder. Furthermore, the second portion 412 includes a second hollow space 414 therewithin. The second hollow space 414 has been provided with the exhaust regulator valve 304 through an orifice in the second portion 412. Further, a spacer protrusion 416 has been provided on the separating wall 410 in the second hollow space 414. The piston 302 includes a first piston end 422 and a second piston 424. The piston 302 is configured to be at least partially disposed within the second hollow space 414. Furthermore, the first piston end 422 is configured to be socketed by the second portion 412. The first piston end 422 further includes a radial protrusion 426. A piston sealing ring 440 is configured to seal a gap between an inner surface of the second portion 412 and the radial protrusion 426 so that no gas escapes from between the radial protrusion 426 and the inner surface of the second portion 412.

A deformable element 420 is disposed between the radial protrusion 426 of the first piston end 422 and the separating wall 410. The deformable element 420 may be selected from a group consisting of a compression spring, a diaphragm, and a fluid chamber filled with a compressible fluid. A first cushion element 418 has been attached to the spacer protrusion 416 at a surface of the spacer protrusion 416 that is facing towards the first piston end 422. A rear cover 438 has been provided at an open end of the second portion 412. A second cushion element 436 has been attached to the rear cover 438 at a surface of the rear cover 438 that is facing towards the separating wall 410. The first 418 and the second 436 cushion elements are configured to prevent wear and tear in the vibration adjusting device 230 during operation by preventing the piston 302 from slamming onto the surfaces at ends of the stroke of the piston 302 during a reciprocating motion of the piston 302.

The second piston end 424 includes a piston mounting head 428. The piston mounting head 428 is configured to be detachably fastened to the gun head 230. In several embodiments of the invention, the piston mounting head 428 may be configured to be detachably fastened to the gun head 230 through one or more of: mating of external threads of the piston mounting head 428 with internal threads of a hole in the gun head 230, mating of external threads of the gun head 230 with internal threads of a hole in the piston mounting head 428, a snap-fit arrangement, and a press-fit arrangement. Further, in several embodiments of the invention, the piston mounting head 428 is configured to be socketed by the gun head 230, and an outer surface 429 of the piston mounting head 428 provided is with one or more third slip rings 430 to prevent relative rotation between the piston mounting head 428 and the gun head 230.

FIG. 5 illustrates a partial side sectional view 500 of the vibration adjusting device 230, in accordance with an embodiment of the present invention. The first piston end 422 with the radial protrusion 426 and the piston sealing ring 440 has been disposed within the second hollow space 414. A portion 502 of the second hollow space 414 between the first piston end 422 (or the radial protrusion 426, as applicable) and the separating wall 410 defines a gas chamber. The gas chamber may be filled with air or any other gaseous substance or gaseous mixture. The exhaust regulator valve 304 is configured to adjust the maximum allowable gas pressure in the gas chamber thereby adjusting the amplitude of the reciprocating motion transmitted to the massage head 240. The reciprocating motion of the gun head 230 due to the actuator 212 is configured to impart reciprocating motion to the piston 302. The reciprocating motion of the piston 302 is configured to impart reciprocating motion to the vibration body 306. The reciprocating motion of the vibration body 306 is configured to impart reciprocating motion to the massage head 240.

In use, as the piston 302 would compress the trapped gas within the gas chamber, a forward linear motion would be imparted to the vibration body 306. The forward linear motion of the vibration body 306 would be transmitted to the massage head 240 due to the direct coupling of the massage head 240 with the vibration body 306. Once the maximum allowable gas pressure is attained inside the gas chamber, the exhaust regulator valve 304 will open and release the pressure within the gas chamber, and any further motion of the piston 302 will have minimal effect on the vibration body 306. The deformable element 420 provided between the piston 302 and the separating wall 410 will cause the vibration body 306 to return to an original position of the vibration body 306 as the piston 302 retracts during a backward stroke of the reciprocating motion of the gun head 230. Therefore, the adjustment of the exhaust regulator wall 304 would be able to affect the amplitude of vibration of the massage head 240.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention and appended claims.

1. A fascial gun, the fascial gun comprising:
a fascial gun body;
a gun head protruding from the fascial gun body and configured to be imparted reciprocating motion by an actuator comprised within the fascial gun body;
a massage head; and
a vibration adjusting device connecting the massage head with the gun head, the vibration adjusting device configured to at least partially transmit the reciprocating motion of the gun head to the massage head,
wherein the vibration adjusting device comprises a gas chamber provided with an exhaust regulator valve configured to adjust maximum allowable gas pressure in the gas chamber thereby adjusting an amplitude of the reciprocating motion transmitted to the massage head.

2. The fascial gun as claimed in claim 1, wherein the actuator is selected from a group consisting of an electrical motor, a linear electromagnetic motor, a piezoelectric actuator, a pneumatic actuator, and a hydraulic actuator.

3. The fascial gun as claimed in claim 1, wherein the vibration adjusting device is detachably fastened with the massage head through one or more of: mating of external threads of the vibration adjusting device with internal threads of a hole in the massage head, a snap-fit arrangement, and a press-fit arrangement.

4. The fascial gun as claimed in claim 1, wherein the vibration adjusting device comprises:
a vibration body comprising a first portion and a second portion, the first portion configured to be fastened to the massage head, and the second portion formed at least in part in form of a cylinder comprising a second hollow space therewithin, the second hollow space provided with the exhaust regulator valve;
a separating wall disposed between the first portion and the second portion; and
a piston comprising a first piston end and a second piston end, the piston configured to be at least partially disposed within the second hollow space with the first piston end configured to be socketed by the second portion, a portion of the second hollow space between the first piston end and the separating wall defining the gas chamber, the second piston end comprising a piston mounting head, the piston mounting head configured to be detachably fastened to the gun head;
wherein the reciprocating motion of the gun head is configured to impart reciprocating motion to the piston,
wherein reciprocating motion of the piston is configured to impart reciprocating motion to the vibration body, and
wherein the reciprocating motion of the vibration body is configured to impart reciprocating motion to the massage head.

5. The fascial gun as claimed in claim 4, further comprising a deformable element disposed between the first piston end and the separating wall.

6. The fascial gun as claimed in claim 5, wherein the deformable element is selected from a group consisting of a compression spring, a diaphragm, and a fluid chamber filled with a compressible fluid.

7. The fascial gun as claimed in claim 4, wherein the piston mounting head is configured to be detachably fastened to the gun head through one or more of: mating of external threads of the piston mounting head with internal threads of a hole in the gun head, mating of external threads of the gun head with internal threads of a hole in the piston mounting head, a snap-fit arrangement, and a press-fit arrangement.

8. The fascial gun as claimed in claim 7, wherein the piston mounting head is configured to be detachably fastened to the gun head through one or more the snap-fit arrangement and the press-fit arrangement, the piston mounted head configured to be socketed by the gun head, and outer surface of the piston mounting head provided with one or more third slip rings to prevent relative rotation between the piston mounting head and the gun head.

9. The fascial gun as claimed in claim 4, wherein the first end of the piston comprises a radial protrusion, wherein the radial protrusion is configured to be in contact with the deformable element.

10. The fascial gun as claimed in claim 4, wherein the first portion is cylindrical in shape and is configured to be socketed by a hole in the massage head, the first portion comprising one or more second slip rings on an outer surface of the first portion to prevent relative rotation between the first portion and the massage head.

11. A vibration adjusting device for a fascial gun comprising a massage head and a gun head, the vibration adjusting device configured to connect the gun head with the massage head, the vibration adjusting device comprising:
a vibration body comprising a first portion and a second portion, the first portion configured to be fastened to the massage head, and the second portion formed at least in part in form of a cylinder comprising a hollow space therewithin, the hollow space provided with an exhaust regulator valve;
a separating wall disposed between the first portion and the second portion; and
a piston comprising a first piston end and a second piston end, the piston configured to be at least partially disposed within the hollow space with the first piston end configured to be socketed by the second portion, a portion of the hollow space between the first piston end and the separating wall defining a gas chamber, the second piston end comprising a piston mounting head, the piston mounting head configured to be detachably fastened to the gun head;
wherein the reciprocating motion of the gun head is configured to impart reciprocating motion to the piston,
wherein reciprocating motion of the piston is configured to impart reciprocating motion to the vibration body,
wherein the reciprocating motion of the vibration body is configured to impart reciprocating motion to the massage head, and
wherein the exhaust regulator valve is configured to adjust maximum allowable gas pressure in the gas chamber thereby adjusting an amplitude of the reciprocating motion transmitted to the massage head.

12. The vibration adjusting device as claimed in claim 11, further comprising a deformable element disposed between the first piston end and the separating wall.

13. The vibration adjusting device as claimed in claim 12, wherein the deformable element is selected from a group consisting of a compression spring, a diaphragm, and a fluid chamber filled with a compressible fluid.

14. The vibration adjusting device as claimed in claim 11, wherein the piston mounting head is configured to be detachably fastened to the gun head through one or more of: mating of external threads of the piston mounting head with internal threads of a hole in the gun head, mating of external threads of the gun head with internal threads of a hole in the piston mounting head, a snap-fit arrangement, and a press-fit arrangement.

15. The vibration adjusting device as claimed in claim 14, wherein the piston mounting head is configured to be detachably fastened to the gun head through one or more the snap-fit arrangement and the press-fit arrangement, the piston mounted head configured to be socketed by the gun head, and outer surface of the piston mounting head provided with one or more third slip rings to prevent relative rotation between the piston mounting head and the gun head.

16. The vibration adjusting device as claimed in claim 11, wherein the first end of the piston comprises a radial protrusion, wherein the radial protrusion is configured to be in contact with the deformable element.

17. The vibration adjusting device as claimed in claim 16, further comprising a front cushion and a rear cushion at a front end and a rear end, respectively, of stroke length of the piston.

18. The vibration adjusting device as claimed in claim 16, further comprising a piston sealing ring provided on an outer surface of the radial protrusion, the piston sealing ring configured to seal the gas chamber to prevent leakage of air or a gaseous substance from a gap in between the outer surface of piston and an inner surface of the second part.

19. The vibration adjusting device as claimed in claim 11, wherein the first portion is cylindrical in shape and is configured to be socketed by a hole in the massage head, the first portion comprising one or more second slip rings on an outer surface of the first portion to prevent relative rotation between the first portion and the massage head.

20. The vibration adjusting device as claimed in claim 11, wherein the exhaust regulator valve is selected from a group consisting of globe valves, gate valves, needle valves, plug valves, and butterfly valves.
